(19) United States
(12) Patent Application Publication
(10) Pub. No.: US 2012/0187034 A1
(43) Pub. Date: Jul. 26, 2012

(54) On-site concrete truck washout filter and treatment apparatus

(76) Inventors: Mark D. Shaw, Ponte Vedra Beach, FL (US); Jacqueline Hahn, Jacksonville, FL (US); Mathew Paul Clancy, Jacksonville, FL (US); Earl Thomas Saxon, JR., North Augusta, SC (US); Dorian Thurston True, III, North Augusta, SC (US)

(21) Appl. No.: 12/930,949

(22) Filed: Jan. 20, 2011

(51) Int. Cl. B01D 35/28

(52) U.S. Cl. 210/201

(57) ABSTRACT

A multi-stage filtering and treatment apparatus comprising a minimum of three stages, wherein the first stage comprises a container for separation of large scale aggregate or particulate matter from the washout slurry, the second stage comprises a container for separation of small scale aggregate or particular matter from the washout slurry, and the third stage comprises a container for separation of suspended particles and fines from the washout slurry and adjustment of the pH as needed. Each such stage comprises a pass-though container that temporarily retains the washout liquid before allowing passage of liquid from one stage container to the next and then out of the apparatus altogether.

### BACKGROUND OF THE INVENTION

This invention relates generally to the field of devices and methods for handling, storing, filtering or treating the washout slurry produced from washing out the wet cement or concrete that has adhered to the delivery chute of a concrete truck.

Once a concrete truck, also known as a cement truck, has delivered its load of wet cement or concrete to a site, a significant portion of the wet material remains adhered to the flop or discharge chute of the vehicle. In years past, it was common practice to simply hose off the discharge chute, allowing the washout liquid to pass into the environment. Given that this washout liquid is detrimental to the environment, EPA regulations now preclude this practice.

One simple solution to the problem is to capture the washout water in a separate container, then transport the container to an appropriate site for treatment and disposal. Alternative solutions involve processing the washout liquid on-site to separate the aggregate from the liquid, with the liquid being cycled back into the concrete truck main rotating chamber.

It is an object of this invention to provide an apparatus and method for processing the washout liquid on-site, the washout liquid being filtered and treated such that the liquid component of the treated washout liquid is adequately processed such that it may be discharged directly into the environment.

### SUMMARY OF THE INVENTION

The invention is a portable apparatus for filtering and treating the washout slurry produced from washing out the wet cement or concrete that has adhered to the delivery chute of a cement or concrete truck after the load of cement or concrete has been discharged from the truck, the apparatus being useable on-site such that the delivery chute may be cleaned on-site, the aggregate material being separated from the washout slurry and the remaining washout liquid being sufficiently treated to allow for release of the liquid directly into the environment, the released liquid meeting or exceeding regulatory standards. The apparatus may also be utilized to clean washout slurry generated from the cleaning of tools, portable concrete mixers, wheelbarrows and the like, as well as processing wet cement or concrete that can be shoveled or vacuumed into the apparatus. The apparatus comprises a plurality of vertically stacked or nested pass-through containers, each container adapted to capture or retain either larger aggregate particles, smaller aggregate particles or suspended particles and fines, in descending order.

The on-site concrete truck washout filter and treatment apparatus is a multi-stage filtering and treatment apparatus comprising a minimum of three stages, wherein the first stage comprises means for separation of large scale aggregate or particulate matter from the washout slurry, the second stage comprises means for separation of small scale aggregate or particular matter from the washout slurry, and the third stage comprises means for separation of suspended particles and fines from the washout slurry and adjustment of the pH as needed. Each such stage comprises a pass-though container that temporarily retains the washout liquid before allowing passage of liquid from one stage container to the next and then out of the apparatus altogether.

### BRIEF DESCRIPTION OF THE DRAWINGS

FIG. 1 is an expanded view of an embodiment of the on-site concrete truck washout filter and treatment apparatus.

FIG. 2 is a cross-sectional view of the embodiment of the on-site concrete truck washout filter and treatment apparatus taken along line II-II of FIG. 1.

FIG. 3 is a top view of the first stage container of the embodiment of the on-site concrete truck washout filter and treatment apparatus shown in FIG. 1.

FIG. 4 is a top view of the second stage container of the embodiment of the on-site concrete truck washout filter and treatment apparatus shown in FIG. 1.

FIG. 5 is a top view of the third stage container of the embodiment of the on-site concrete truck washout filter and treatment apparatus shown in FIG. 1.

FIG. 6 is a partial cross-sectional view, similar to the cross-sectional view of FIG. 2, showing an alternative embodiment for the second and third stage containers of the on-site concrete truck washout filter and treatment apparatus.

FIG. 7 is a partial view showing the addition of a final stage filter member connected to an outlet conduit of the third stage container of the on-site concrete truck washout filter and treatment apparatus.

FIG. 8 is a partial cross-sectional view, showing another alternative embodiment of the on-site concrete truck washout filter and treatment apparatus, which includes a vacuum pump for drawing washout liquid into the apparatus.

### DETAILED DESCRIPTION OF THE INVENTION

With reference to the drawings, the on-site concrete truck washout filter and treatment apparatus will now be described in detail with regard for the best mode and the preferred embodiment or embodiments. In a broad sense, the invention is a portable apparatus for filtering and treating the washout slurry produced from washing out the wet cement or concrete that has adhered to the delivery chute of a cement or concrete truck after the load of cement or concrete has been discharged from the truck, the apparatus being useable on-site such that the delivery chute may be cleaned on-site, the aggregate material being separated from the washout slurry and the remaining washout liquid being sufficiently treated to allow for release of the liquid directly into the environment, the released liquid meeting or exceeding regulatory standards. The apparatus may also be utilized to clean washout slurry generated from the cleaning of tools, portable concrete mixers, wheelbarrows and the like, as well as processing wet cement or concrete that can be shoveled or vacuumed into the apparatus. The apparatus comprises a plurality of vertically stacked or nested pass-through containers, each container adapted to capture or retain either larger aggregate particles, smaller aggregate particles or suspended particles and fines, while allowing passage of liquid through the apparatus.

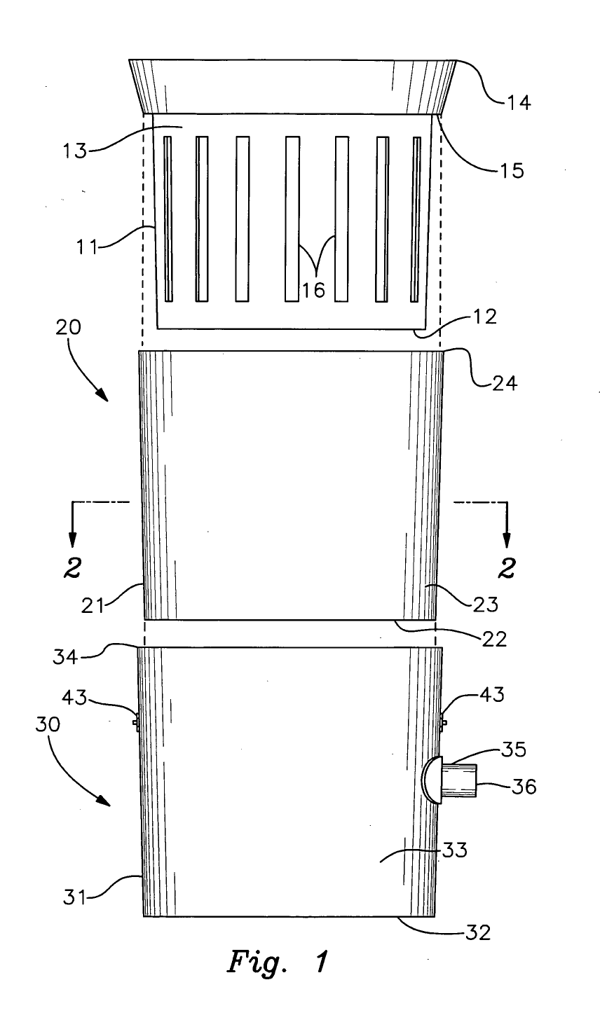

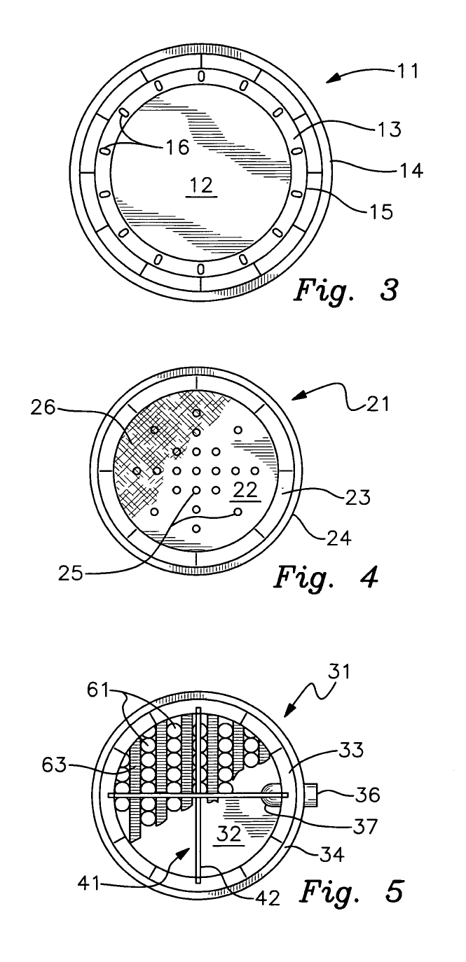

An embodiment of the on-site concrete truck washout filter and treatment apparatus is shown in FIGS. 1 through 5. The on-site concrete truck washout filter and treatment apparatus is a multi-stage filtering and treatment apparatus comprising a minimum of three stages, wherein the first stage comprises means 10 for separation of large scale aggregate or particulate matter from the washout slurry, the second stage comprises means 20 for separation of small scale aggregate or particular matter from the washout slurry, and the third stage comprises means 30 for separation of suspended particles and fines from the washout slurry. Each such stage comprises a pass-though container 11, 21 or 31 allowing passage of liquid from one stage container to the next and then out of the apparatus altogether. Most preferably containers 11, 21 and 31 are composed of a durable plastic material, but other materials such as metal may also be suitable for the purpose.

The means 10 for separation of large scale aggregate or particulate matter from the washout slurry comprises a first stage large aggregate separator container 11, the container 11 comprising a bottom 12, a side wall 13, preferably annular, and a rim 14 defining an open top. In the embodiment shown in FIGS. 1 through 3, the large aggregate separator container 11 further comprises a shoulder flange 15. The shoulder flange 15 is a structure that allows the first stage container 11 to be positioned such that when container 11 is stacked or nested with the second stage small aggregate separator container 21, the bottom 12 of container 11 is suspended a distance above bottom 21 of container 21 in order to account for the build-up of small scale aggregate or particulate matter, such as small gravel or sand. The first stage container 11 further comprises a plurality of vertical slots 16 disposed in the side wall 13, the slots 16 being sized to prevent passage of large scale aggregate or particulate matter, such as large gravel. A suitable width for example for slots 16 is approximately ¼ inch, such that any particles or aggregate having dimension greater than ¼ inch will be retained within first stage container 11, while particulate or aggregate having dimension less than ¼ inch, along with the liquid slurry created in the washout process, will pass from first stage container 11 through slots 16 and into second stage container 21.

The purpose of the vertical slots 16 is to allow for a significant amount of unrestricted passage and flow through the first stage container 11 even when a large amount of large scale aggregate is trapped and retained by the first stage container 11. The bottom 12 of first stage container 11 may also be provided with apertures or slots sized correspondingly to vertical slots 16, but bottom 11 is preferably solid in order to maintain sufficient weight-bearing strength for when the first stage container 11 is removed from the apparatus to empty the collected large scale aggregate.

The means 20 for separation of small scale aggregate or particulate matter from the washout slurry comprises a second stage small aggregate separator container 21, the container 21 comprising a bottom 22, a side wall 23, preferably annular, and a rim 24 defining an open top. The bottom 22 of second stage container 21 is provided with a plurality of holes or perforations 25, the perforations preferably being of smaller size than the width of the vertical slots 16 in first stage container 11. A suitable size for example for perforations 25 is approximately ⅛ inch in diameter. The second stage container 21 further comprises a mesh or screen 26 disposed above and across bottom 22. The mesh 26 is provided with openings significantly smaller than the width of the vertical slots 16, the mesh openings being for example approximately 1/16 inch in width. In this manner, small scale particulate and aggregate matter, such as sand and small gravel particles that have passed through the vertical slots 16 of first stage container 11, are trapped and retained within second stage container, while only entrained tiny particles and fines suspended within the liquid washout slurry pass from second stage container 21 into third stage container 31, the second stage container 21 being nested or vertically stacked with or relative to third stage container 31.

The means 30 for separation of suspended particles and fines from the washout slurry comprises a third stage treatment separator container 21, the container 31 comprising a bottom 32, a side wall 33, preferably annular, and a rim 34 defining an open top. Third stage container 31 receives and retains the second stage container 21 in a nested or stacked manner. Whereas the distance between the bottom 12 of first stage container 11 and the bottom 22 of second stage container 21 is preferably less than half the height of second stage container 21, the distance between the bottom 22 of second stage container 21 and the bottom 32 of third stage container 31 is much greater, preferably being at least half the height of third stage container 31, thus providing a relatively large volume sump to receive the liquid slurry that passes through second stage container 21.

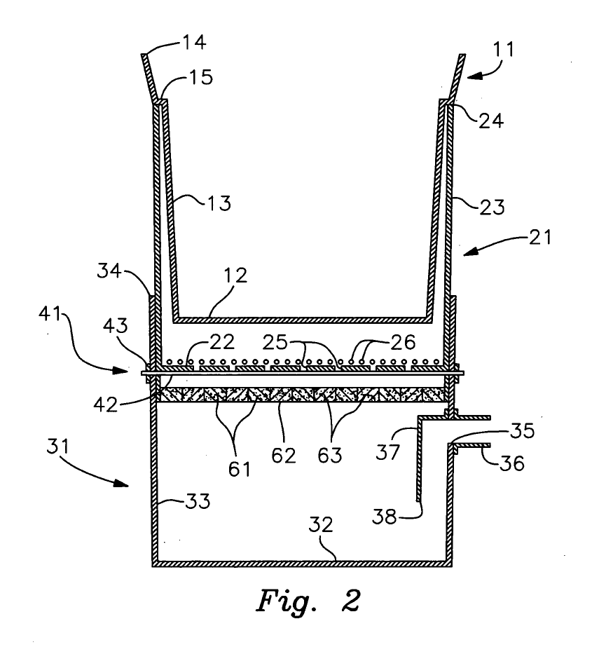

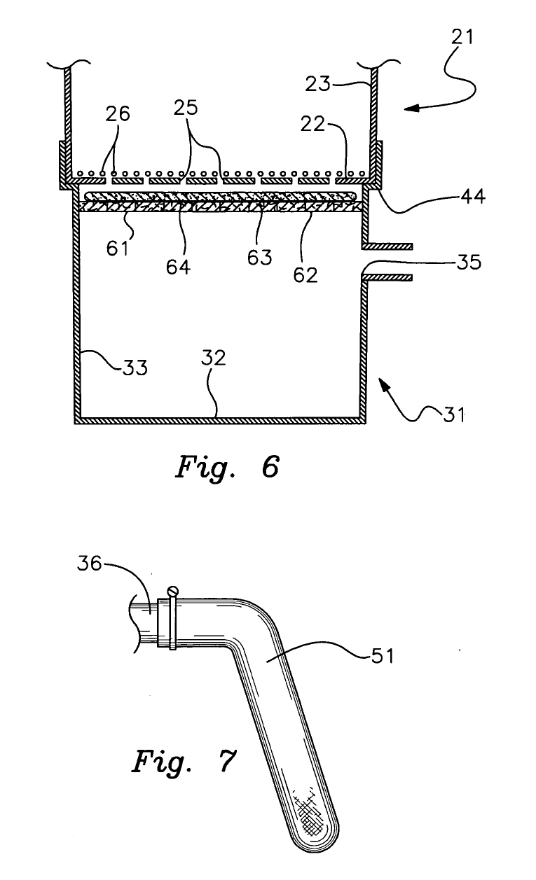

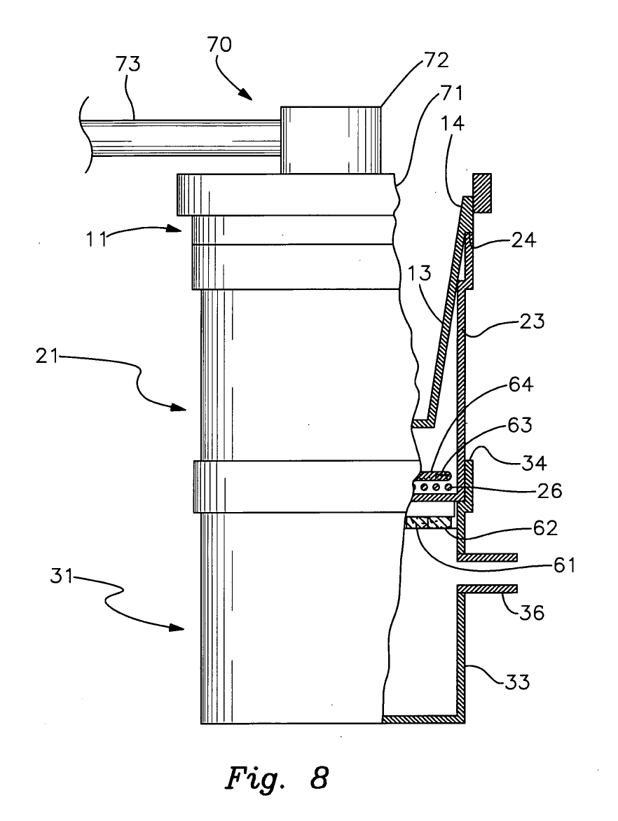

One structure for receiving and retaining second stage container 21 in proper position is to provide transverse support members 41 extending across the interior of third stage container 31, such that the bottom 22 of second stage container 21 rests upon and is supported by the support members 41. As shown in FIGS. 2 and 5, the transverse support members 41 may for example comprise rods 42 fastened to the side wall 33 of third stage container 31 by fastening members 43. In an alternative construction, as shown in FIGS. 6 and 8, the third stage container 31 may be provided with an annular shoulder seat 44 that receives and support the out perimeter of the bottom 22 of second stage container 21.

A side outlet 35 is positioned in the side wall 33 of third stage container 31, the outlet 35 being positioned approximately halfway or greater up side wall 33. Outlet 35 may be formed integrally with side wall 33 and may also be provided with a conduit member 36 for connection with a hose (not shown) or final stage filter 51, as shown in FIG. 7. Preferably, the third stage container 31 also comprises a shroud member 37 that encircles or covers the interior opening of outlet 35, the shroud member 37 being open only on the bottom, the shroud opening 38 being located below the out 35. With this structure, when the liquid level within third stage container 31 rises above the level of the bottom opening 38 of shroud member 37, the shroud member 37 prevents the liquid slurry from passing immediately through the outlet 35. Instead, the liquid slurry remains in the third stage container for a sufficient period of time to allow for chemical treatment of the liquid such that sedimentation of suspended particulates and fines from the liquid occurs. In addition, the shroud member 37 precludes floating debris from passing through side outlet 35.

The large internal volume of the third stage container 31 provides an extended residence time of liquid within the container 31, thereby allowing suspended particles and fines carried by the liquid slurry to settle onto the bottom of third stage container 31, such that liquid passing through outlet 35 contains a relatively small amount of entrained matter. In practice however, it is necessary to increase the rate of sedimentation in order to insure that the majority of suspended particles and fines settle out of the liquid slurry prior to discharge from the apparatus. The rate of sedimentation is accelerated by exposing the liquid slurry to a flocculating agent 61, which can be supplied in the form of disks that dissolve over time upon contact with liquid. Flocculating agents 61 are well known in the art, and suitable agents may include but are not limited to for example alum, organic polyelectrolytes, Arabic gum, chitosan, protein derivatives, anionic calcium salts and the like. The flocculating agent 61 may be placed on the bottom 32 of third stage container 31 or the bottom 22 of second stage container 21, but most preferably are suspended within the upper interior of third stage container 31, such as within a mesh or otherwise liquid-impermeable container 62 suspended or otherwise fastened to the rim 34, side wall 33 or support members 41, as shown in FIGS. 2, 6 and 8, such that liquid slurry passing from second stage container 21 flows onto and through the flocculating agent 61. Suspending the flocculating agents 61 in the upper interior of third stage container 31 and above the outlet 35 prevents the flocculating agents 61 from being occluded by trapped aggregate or particulate matter, and from being buried within sediment released from the liquid slurry. Suspension of the flocculent also allows a steady stream or flow of liquid to impact the flocculent, causing sufficient amounts of flocculent to be eroded, dissolved or liquefied to create the proper concentration within the liquid contained in the third stage container 31 for sedimentation of the suspended solids and fines.

To insure that the liquid discharged from the on-site concrete truck washout filter and treatment apparatus exceeds minimum standards for discharge directly into the environment on-site, it is preferred to also provide a pH adjusting or neutralizing agent 63, since the pH of the liquid slurry is considerably basic. Suitable pH adjusting agents 63 for example include but are not limited to sulfuric acid, hydrochloric acid, phosphoric acid, nitric acid, citric acid or the like. A typical washout slurry will have a pH of about 11.5 to 12.8, which must reduced to approximately 6 to 9 pH to meet EPA regulations for discharge into the environment. The flocculating agent 63 may be provided in particulate or disk form, and may be freely dispensed into the interior of third stage container 31, may be retained within the mesh container 62 suspended within third stage container 31, as shown in FIG. 2, may be retained within a soluble container or pouch 64 as shown positioned directly above the flocculating agent 61 in FIG. 6, or positioned atop the mesh 26 within second stage container 21 as in FIG. 8. Since the pH adjusting agent 63 will be immediately dissolved upon liquid contact, it may even be positioned within first stage container 11 if desired.

As one more safeguard, the on-site concrete truck washout filter and treatment apparatus may further comprise a final stage filter 51 connected to said conduit 36, shown in FIG. 7 as a sock-like or closed tube composed of a filtering fabric, mesh, felt or like material, the final stage filter 51 having apertures of lesser dimension than the openings of mesh member 26, such as for example less than 1/16 inch to retain any particulates or fines that pass from the third stage container. Furthermore, it is also contemplated that additional stage containers could be provided beyond the three stages identified above, the additional stage containers having permeability dimensions greater or in mid-range between the permeability dimensions of the containers described above.

In another alternate embodiment, the on-site concrete truck washout filter and treatment apparatus may be provided with a means 70 for suctioning liquid slurry into the apparatus, as shown in FIG. 8. The means 70 for suctioning liquid slurry may comprise a suction or vacuum pump 72 connected to or mounted onto a cap member 71 adapted to fit onto or be received by the rim 14 of first stage container 11, a conduit 73 being in communication with the pump 72. In this manner, the liquid slurry can be drawn from the delivery chute of the concrete truck and discharged into the first stage container 11 for treatment. Furthermore, with this construction, standing washout liquid or other liquid slurry, such as may be found on-site within buckets used to clean tools, within other reservoirs or sumps, or concrete waste water spread out on a floor or slab, may be suctioned into the apparatus for treatment. Preferably, the means for nesting or stacking the first, second and third stage containers 11, 12 and 13 are structured such that the vacuum cap 71 can be mounted onto any of the three stage containers 11, 12 or 13, since in some circumstances the washout liquid or liquid slurry may not contain any significant aggregate material and the screening and filtering of the first stage container 11 and/or the second stage container 21 may not be required.

The dimensions of the apparatus are not critical, but it is preferable that the apparatus be readily portable by hand, such that the apparatus can be transported and the three stages of the apparatus be easily assembled at a location where treatment and filtering of washout liquid or liquid slurry is needed. Where access to a forklift or other powered device is available, the apparatus may be sized mush larger. For the manually portable apparatus, the size of the apparatus and especially the size of first stage container 11 should be limited, since the first stage container 11 is to be removed from the second stage container 21 when the first stage container 11 is filled with large scale aggregate. As an example only, expressly stating that the dimensions are not meant to limiting, it has been found that containers having a volume of approximately 20 gallons, with a diameter of about 23 inches and an overall height when nested or stacked of about 37 inches. Such an apparatus can retain about 125 to 150 pounds of large scale aggregate in the first stage container 11.

In utilizing the apparatus, it is preferable to pre-charge the apparatus by adding several gallons of clean water in order to dissolve the pH adjusting agent 63 and some of the flocculating agent 61. This produces a treatment solution within third stage container 31 ready to act upon the initial liquid slurry passing into the third stage container 11. The delivery chute of the concrete truck is then hosed down in normal manner, keeping watch that the rate of washout liquid passing into the apparatus does not exceed its flow-through capacity. With the dimensions set for in the example above, the apparatus can treat and handle about 10 to 12 gallons per minute, with most chute washouts requiring about 15 to 20 gallons of water. In testing the apparatus as described has been shown to effectively reduce the turbidity of the liquid slurry to less than 40 NTUs (Nephelometric Turbidity Units) and to reduce the pH to below 8.5, well within the EPA guidelines allowing discharge of the liquid directly into the environment.

It is understood that equivalents and substitutions for certain elements set forth above may be obvious to those of ordinary skill in the art, and thus the true scope and definition of the invention is to be as set forth in the following claims.

We claim:

1. A portable concrete washout filter and treatment apparatus, said apparatus adapted to separate large scale aggregate, small scale aggregate and suspended particulates or fines from a washout slurry, and further adapted to adjust the pH of the washout slurry, such that the processed liquid is sufficiently filtered and treated that it may be safely released into the environment, said apparatus comprising:
a first stage large scale aggregate separator container, a second stage small scale aggregate container, and a third stage treatment separator container, said containers being vertically nested or stacked in a separable manner such that liquid from washout slurry passes from said first stage container to said second stage to said third stage container and out of said third stage container;
said first stage container comprising a bottom, a side wall and vertical slots disposed in said side wall, said vertical slots preventing passage of large scale aggregate from said first stage container to said second stage container while allowing passage of small scale aggregate and liquid containing suspended particulates and fines;
said second stage container comprising a bottom, a side wall, perforations in said bottom, and a mesh member disposed across said bottom, said mesh member having openings preventing passage of small scale aggregate from said second stage container to said third stage container while allowing passage of liquid containing suspended particulates and fines;
said third stage container comprising a bottom, a side wall, and an outlet disposed in said side wall;
said apparatus further comprising a flocculating agent, said flocculating agent causing sedimentation of said suspended particulates and fines from said liquid resident within said third stage container prior to passage of said liquid through said outlet; and
said apparatus further comprising a pH adjusting agent, said pH adjusting agent acting upon said liquid resident within said third stage container prior to passage of said liquid through said outlet.

2. The apparatus of claim 1, further comprising a shroud member positioned on the interior side of said outlet of said third stage container, said shroud member having an opening located beneath said outlet such that said liquid entering said third stage container cannot pass through said outlet without passing through said shroud opening.

3. The apparatus of claim 1, wherein said bottom of said second stage container is positioned relative to said bottom of said third stage container such that the distance from said second stage bottom to said third stage bottom is greater than half the height of said third stage container.

4. The apparatus of claim 1, wherein the width of said vertical slots of said first stage container is approximately ¼ inch and the width of said mesh member openings of said second stage container are approximately 1/16 inch.

5. The apparatus of claim 1, wherein said first stage container further comprises a shoulder flange and said second stage container comprises a rim, said first stage container shoulder flange abutting said second stage container rim when said first and second stage containers are stacked or nested.

6. The apparatus of claim 1, wherein said third stage container further comprises a support member extending between said third stage container side wall, said third stage container support member supporting said second stage container bottom when said second and third stage containers are stacked or nested.

7. The apparatus of claim 5, wherein said third stage container further comprises a support member extending between said third stage container side wall, said third stage container support member supporting said second stage container bottom when said second and third stage containers are stacked or nested.

8. The apparatus of claim 1, wherein said flocculating agent is suspended above said third stage container bottom.

9. The apparatus of claim 1, said third stage container further comprising a conduit positioned at said outlet, the apparatus further comprising a final filter connected to said conduit, said final filter having apertures of lesser dimension than said second stage container mesh openings.

10. The apparatus of claim 1, wherein said first, second and third stage containers each comprise a rim of equal dimension.

11. The apparatus of claim 10, further comprising a vacuum pump connected to a cap member, said cap member sized so as to fit onto said first stage, second stage or third stage container rims.

12. A portable concrete washout filter and treatment apparatus, said apparatus adapted to separate large scale aggregate, small scale aggregate and suspended particulates or fines from a washout slurry, and further adapted to adjust the pH of the washout slurry, such that the processed liquid is sufficiently filtered and treated that it may be safely released into the environment, said apparatus comprising:
means for separation of large scale aggregate matter from said washout slurry, means for separation of small scale aggregate from said washout slurry, and means for separation of suspended particulates and fines from said washout slurry, said large scale aggregate separation means, said small scale aggregate separation means and said suspended particulates and fines separation means being vertically nested or stacked;
said large scale aggregate separation means comprising a bottom, a side wall and vertical slots disposed in said side wall, said vertical slots preventing passage of large scale aggregate from said large scale aggregate separation means to said small scale aggregate separation means while allowing passage of small scale aggregate and liquid containing suspended particulates and fines;
said small scale aggregate separation means comprising a bottom, a side wall, perforations in said bottom, and a mesh member disposed across said bottom, said mesh member having openings preventing passage of small scale aggregate from said small scale aggregate separation means to said suspended particulates and fines separation means while allowing passage of liquid containing suspended particulates and fines;
said suspended particulates and fines separation means comprising a bottom, a side wall, and an outlet disposed in said side wall;
said apparatus further comprising a flocculating agent, said flocculating agent causing sedimentation of said suspended particulates and fines from said liquid resident within said suspended particulates and fines separation means prior to passage of said liquid through said outlet; and
said apparatus further comprising a pH adjusting agent, said pH adjusting agent acting upon said liquid resident within said suspended particulates and fines separation means prior to passage of said liquid through said outlet.

13. The apparatus of claim 12, further comprising a shroud member positioned on the interior side of said outlet of said suspended particulates and fines separation means, said shroud member having an opening located beneath said outlet such that said liquid entering said suspended particulates and fines separation means cannot pass through said outlet without passing through said shroud opening.

14. The apparatus of claim 12, wherein said bottom of said small scale aggregate separation means is positioned relative to said bottom of said suspended particulates and fines separation means such that the distance from said small scale aggregate separation means bottom to said suspended particulates and fines separation means bottom is greater than half the height of said suspended particulates and fines separation means.

15. The apparatus of claim 12, wherein the width of said vertical slots of said large scale aggregate separation means is approximately ¼ inch and the width of said mesh member openings of said small scale aggregate separation means are approximately 1/16 inch.

16. The apparatus of claim 12, wherein said large scale aggregate separation means further comprises a shoulder flange and said small scale aggregate separation means comprises a rim, said large scale aggregate separation means shoulder flange abutting said small scale aggregate separation means rim when said large scale aggregate separation means and small scale aggregate separation means are stacked or nested.

17. The apparatus of claim 12, wherein said suspended particulates and fines separation means further comprises a support member extending between said suspended particulates and fines separation means side wall, said suspended particulates and fines separation means support member supporting said small scale aggregate separation means bottom when said small scale aggregate separation means and large scale aggregate separation means are stacked or nested.

18. The apparatus of claim 16, wherein said suspended particulates and fines separation means further comprises a support member extending between said suspended particulates and fines separation means side wall, said suspended particulates and fines separation means support member supporting said small scale aggregate separation means bottom when said small scale aggregate separation means and said suspended particulates and fines separation means are stacked or nested.

19. The apparatus of claim 12, wherein said flocculating agent is suspended above said suspended particulates and fines separation means bottom.

20. The apparatus of claim 12, said suspended particulates and fines separation means further comprising a conduit positioned at said outlet, the apparatus further comprising a final filter connected to said conduit, said final filter having apertures of lesser dimension than said small scale aggregate separation means mesh openings.

21. The apparatus of claim 12, wherein said large scale aggregate separation means, said small scale aggregate separation means, and said suspended particulates and fines separation means each comprise a rim of equal dimension.

22. The apparatus of claim 10, further comprising a vacuum pump connected to a cap member, said cap member sized so as to fit onto said large scale aggregate separation means, said small scale aggregate separation means, or said suspended particulates and fines separation means rims.
